(19) United States
(12) Patent Application Publication
(10) Pub. No.: US 2014/0080542 A1
(43) Pub. Date: Mar. 20, 2014

(54) PORTABLE ELECTRONIC DEVICE

(71) Applicant: PEGATRON CORPORATION, Taipei City (TW)

(72) Inventors: Shu-Yin PAN, Taipei City (TW); Meng-Han KO, Taipei City (TW); Hua-Yu HUANG, Taipei City (TW); Che-Chen KUO, Taipei City (TW)

(73) Assignee: PEGATRON CORPORATION, Taipei City (TW)

(21) Appl. No.: 13/893,951

(22) Filed: May 14, 2013

(30) Foreign Application Priority Data
Sep. 14, 2012 (TW) 101133799

(51) Int. Cl. H04M 1/02

(52) U.S. Cl. CPC H04M 1/0264
USPC 455/556.1

(57) ABSTRACT

A portable electronic device includes a main body, a camera and a sliding cover structure. One surface of the main body has a convex portion and a planar portion. The camera and the sliding cover are provided at the planar portion. The sliding cover structure includes an inclined slideway and a cover having at least one sliding portion. The inclined slideway inclines from the convex portion to the camera to form an inclined angle with a horizontal axis of the main body. The cover slides along the inclined slideway via the sliding portion and movably covers the camera. When the cover covering the camera slides to the convex portion and partially covers the convex portion, the camera is exposed. The sliding cover structure protects the camera on the portable electronic device, and the functions of real-time camera activation are achieved while the comfort of user gripping is enhanced.

### CROSS-REFERENCE TO RELATED APPLICATIONS

This Non-provisional application claims priority under 35 U.S.C. §119(a) on Patent Application No(s). 101133799 filed in Taiwan, Republic of China on Sep. 14, 2012, the entire contents of which are hereby incorporated by reference.

### BACKGROUND OF THE INVENTION

1. Field of Invention

The invention relates to a portable electronic device and, in particular, to a portable electronic device with a sliding cover structure.

2. Related Art

With the development of technology and the pursuit of a higher quality of life, many electronic devices have been developed. To maximize the performances of the electronic devices, various kinds of electronic devices with hand-held operation functionalities have been come out with the trend of more compact, aesthetic and multi-functional. Among the various kinds of electronic devices, smartphones have been popularized rapidly which benefits human by enhancing the conveniences of life and transactions.

Currently most smartphones have camera functions, and mostly a camera is disposed at the back of a smartphone. However, with such design, the camera is exposed outside of the smartphone regardless of whether the camera is in use. Except for the performance of the camera module, the wear and pollution from the outside also affect the durability of the camera significantly. However, most digital cameras of the smartphones available on the market lack of protection mechanisms, therefore it is easy for the cameras to be worn. The moisture and dust in the air are also easy to he attached to a camera, which affects the image quality of the digital camera, reduces the lifespan of the digital camera, and brings inconvenience to the user.

Moreover, since the current smartphones have the trend of compactness, they suffer from the problem of insufficient gripping for the user when the user is operating the camera. That is, since the smartphone is too thin, the thickness for the user to grip the smartphone is insufficient when the user is using the camera. Therefore the comfort of gripping when taking photos cannot be satisfied.

Therefore, how to provide a sliding cover structure of a mobile phone, which is easy to operate, highly convenient and comfortable, can assist the user of the smartphone to operate the built-in camera, and can further improve the operation of the built-in camera and protect the structure of the camera has become an important issue to be solved.

### SUMMARY OF THE INVENTION

In view of the above issue, an objective of the invention is to provide a sliding cover structure for a phone that can assist the user to operate the built-in camera of a smartphone, that is easy to operate, and that is highly convenient and comfortable to use, so that the operability of the built-in camera of the smartphone is enhanced and the structure of the camera is protected.

To achieve the above-mentioned objective, a portable electronic device according to the invention includes a main body, a camera and a sliding cover structure. One surface of the main body has a convex portion and a planar portion. The camera is provided at the planar portion. The sliding cover structure is provided at the planar portion and includes an inclined slideway and a cover. The inclined slideway is provided at the planar portion and inclines from the convex portion to the camera to form an inclined angle with a horizontal axis of the main body. The cover has at least one sliding portion, and slides along the inclined slideway via the sliding portion to movably cover the camera. When the cover covering the camera slides to the convex portion and at least a portion of the cover covers the convex portion, the camera is exposed.

In one embodiment, when the cover is provided at the planar portion and covers the camera, the cover and the convex portion are substantially in a flat state.

In one embodiment, the sliding portion is slid ably lodged at the inclined slideway.

In one embodiment, the inclined slideway further includes two fixing portion, and the sliding portion is slidably sleeved at the fixing portions.

In one embodiment, the portable electronic device further includes a stop portion provided at the inclined slideway

In one embodiment, when the camera is completely exposed, the stop portion stops the slide of the cover.

In one embodiment, when the stop portion stops the slide of the cover, the angle between the cover and the main body equals to the inclined angle.

In one embodiment, when the cover covers the camera completely, the convex portion is exposed completely.

In one embodiment, when the cover covering the camera slides to the convex portion and at least a portion covers the convex portion, the portable electronic device activates function of the camera.

In one embodiment, the inclined slideway includes a first inclined surface and a second inclined surface, the slope of the first inclined surface is larger than the slope of the second inclined surface.

Based on the above, the sliding cover structure provided by the invention is used with a portable communication device, such as a smartphone. By providing a slidable cover on a slim-type smartphone, the cover can cover the camera on the back of the smartphone, so that the camera can be isolated from the external factors affecting the image quality, such as moisture, dusts and mechanical damages, and the protection function can be achieved.

The portable electronic device (such as but not limited to a smartphone) with the sliding cover structure of the invention is designed that the camera function can be activated quickly when the cover is opened to expose the camera. That is, the invention can use the sliding cover structure as a real hotkey to replace the operation unit in the smartphone and achieve the advantage of slide-and-shoot.

Moreover, with the design of having an inclined angle inside the sliding cover structure, the smartphone can maintain its compactness by accommodating the cover in the space of the slideway when the cover covers the camera. When the cover slides along the convex portion on the back of the phone to expose the camera, the cover overlaps with the convex portion on the same side of the phone, and the gripping thickness for the user can be increased through such overlap. In practical applications, the sliding cover structure of the invention allows the phone to maintain its compactness while thickening the phone locally via the slidable cover to increase the degree of comfort when gripping for photo-taking.

### BRIEF DESCRIPTION OF THE DRAWINGS

The invention will become more fully understood from the detailed description and accompanying drawings, which are given for illustration only, and thus are not limitative of the present invention, and wherein:

FIG. 1A is a schematic diagram of the outer appearance of the portable electronic device according to the preferred embodiment of the invention;

FIG. 1B is a schematic diagram showing the operation of the cover of the portable electronic device shown in FIG. 1A;

FIG. 1C is a dissembled schematic diagram of the portable electronic device shown in FIG. 1A;

FIG. 2A is a side view of a portable electronic device according to a preferred embodiment of the invention;

FIG. 2B is a side view showing the operation of the cover of the portable electronic device shown in FIG. 2A;

FIG. 2C is a partial perspective view of the portable electronic device shown in FIG. 2A; and

FIG. 3 is a side view of the portable electronic device according to another preferred embodiment of the invention.

### DETAILED DESCRIPTION OF THE INVENTION

The present invention will be apparent from the following detailed description, which proceeds with reference to the accompanying drawings, wherein the same references relate to the same elements.

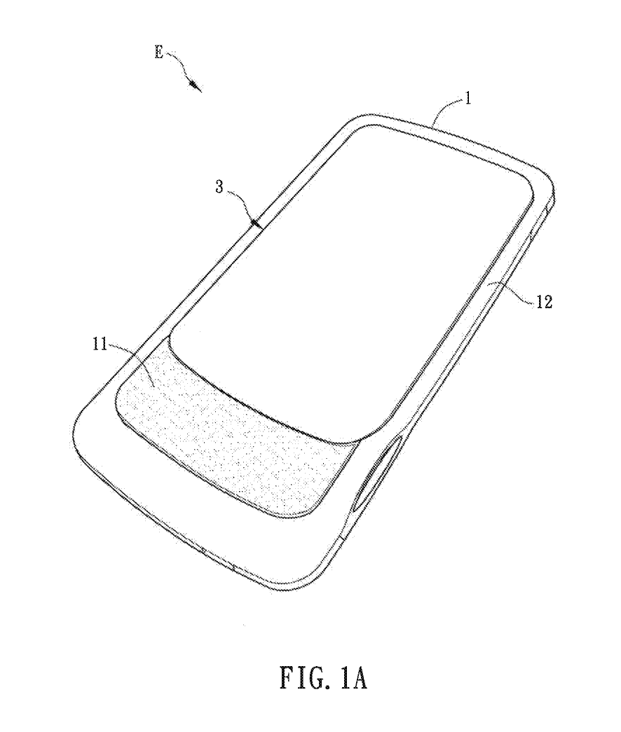

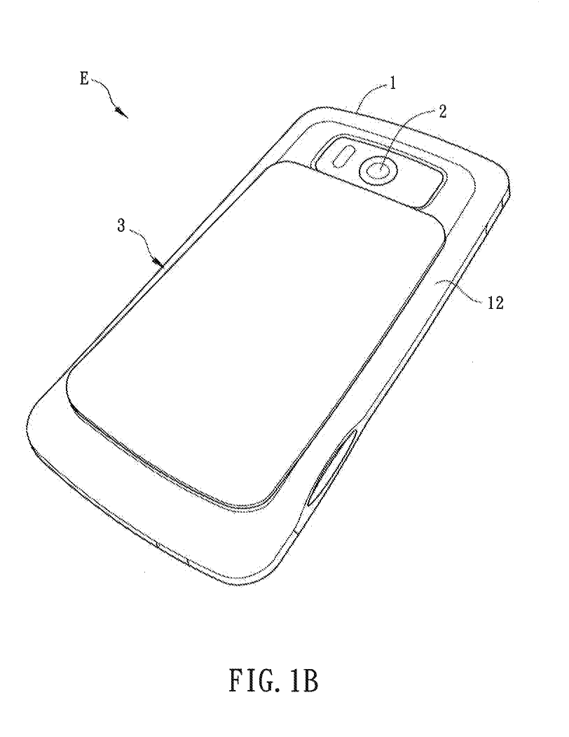

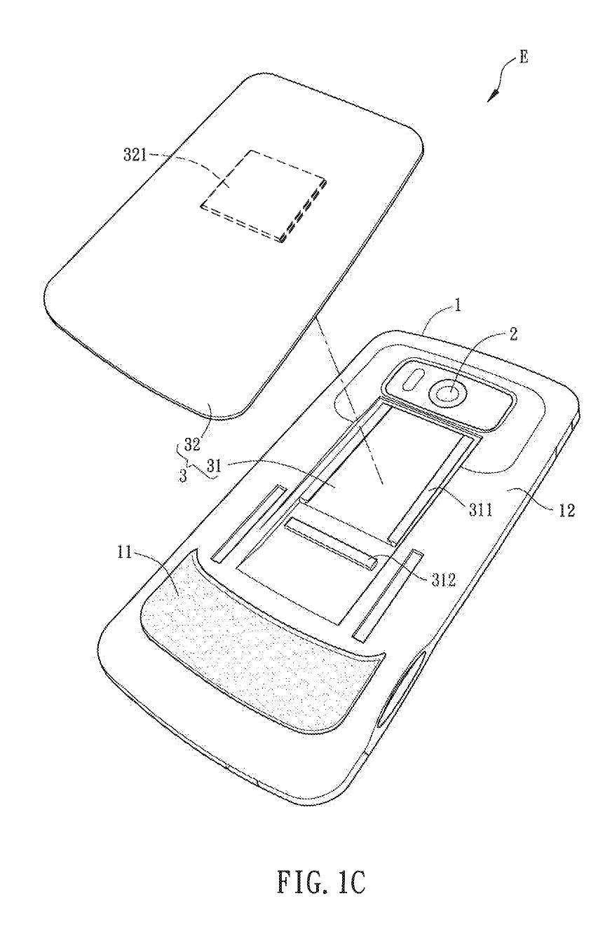

FIG. 1A is a schematic diagram of the outer appearance of the portable electronic device according to the preferred embodiment of the invention. FIG. 1B is a schematic diagram showing the operation of the cover of the portable electronic device shown in FIG. 1A. FIG. 1C is a dissembled schematic diagram of the portable electronic device shown in FIG 1A. Please refer to FIG. 1A, 1B and 1C at the same time. In the present embodiment, the portable electronic device E includes a main body 1, a camera 2 and a sliding cover structure 3. In the present embodiment, a smartphone is taken as an example, which is not limitative. In practical applications, the portable electronic device may be a tablet PC. It should be noted that the front surface of the main body 1 of the portable electronic device E of the embodiment may be, but not limited to, a touch screen of the smartphone. However, the embodiment neither improves nor limits the front surface of the main body. Therefore, both the disclosures and the drawings show and describe the back surface of the main body. The structural features of the components of the portable electronic device E will be described below.

Referring to FIG. 1A and FIG. 1C simultaneously, the back surface of the main body 1 has a convex portion 11 and a planar portion 12. The convex portion 11 is provided at one end of the back surface of the main body 1. In the present embodiment, the convex portion 11 is a bump structure, which may be made of plastic without limiting sense. The convex portion 11 allows the sliding cover structure 3 to slide smoothly. Therefore, the smaller the friction between the convex portion 11 and the sliding cover structure 3, the better.

The camera 2 is disposed at the end of planar portion 12 opposite to the convex portion 11. The sliding cover structure 3 is also provided at the planar portion 12 and covers the camera 2. When the cover 32 is provided at the planar portion 1 and covers the camera 2, the cover 32 and the convex portion 11 is at a substantially flat state. The “flat state” mentioned here is not limited to a completely flat state, but may include, for example, manufacturing defects, certain special situations, or theoretical or practical allowable tolerances.

The sliding cover structure 3 includes an inclined slideway 31 and a cover 32. The cover 32 is a rectangular thin shell, and has a sliding portion 321 at the side near the planar portion. The inclined slideway 31 is provided at the planar portion 12. In the present embodiment, the inclined slideway 31 may be an accommodation space that can just accommodate the sliding portion 321 of the cover 32 substantially. The sliding portion 321 is movably provided at the inclined slideway 31. In detail, the sliding portion 321 is slidably-fitted at the inclined slideway 31, and the two sides of the sliding portion 321 may be fixed through the fixing portions 311 disposed at the two sides of the inclined slideway 31 to limit the sliding direction and range of the cover 32. Through the sliding portion 321, the cover 32 is movably disposed at the back surface of the portable electronic device E. Moreover, in the present embodiment, height H1 of the convex portion 11 is equal to the depth H2 of the inclined slideway. Such design is helpful for the sliding portion 321 to move in the inclined slideway 31 with the assistance of the convex portion 11 so that the problem of damage due to collisions is not caused.

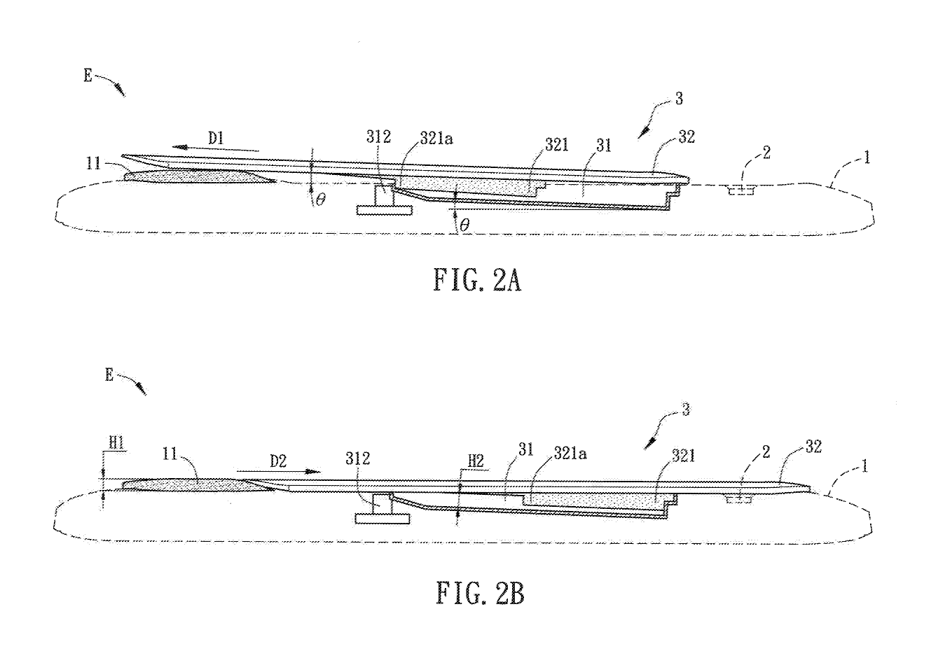

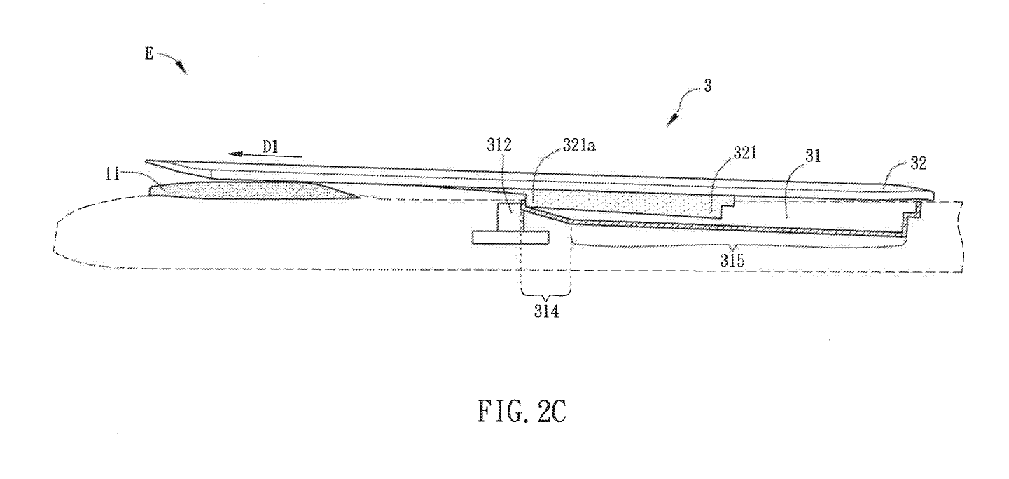

FIG. 2A is a side view of a portable electronic device according to a preferred embodiment of the invention. FIG. 2B is a side view showing the operation of the cover of the portable electronic device shown in FIG. 2A. FIG. 2C is a partial perspective view of the portable electronic device shown in FIG. 2A. Please refer to FIGS. 2A, 2B and 2C simultaneously. The inclined slideway 31 includes a first inclined surface 314 and a second inclined surface 315, and the slope of the first inclined surface 314 is larger than the slope of the second inclined surface 315. The inclined slideway 31 inclines from one side of the convex portion 11 toward one side of the camera 2, so that the inclined slideway 31 has an inclined angle θ with respect to a horizontal axis of the main body 1. The horizontal axis of the main body 1 refers to the direction parallel to a flat surface on which the portable electronic device E is placed. That is, the inclined angle θ is formed between the incline slideway 31 and the flat surface.

When the sliding cover structure 3 slides toward the convex portion 11, the cover 32 moves in parallel with the second inclined surface 315 via the sliding portion 321. At this moment, the cover 32 slides along an opening direction D1. When the cover 32 moves from one side of the camera 2 to the convex portion 11 until the camera 2 is fully exposed without being blocked, the first end 321a of the sliding portion 321 near the convex portion 11 is stopped by a stop portion 312 in the inclined slideway 31. At this moment, the angle between the cover 32 and the main body 1 equals to the inclined angle θ between the inclined slideway 31 and the horizontal axis of the main body 1. Under this situation, at least a portion of the convex portion 11 is covered by the cover 32, and the portable electronic device E can activate the function of the camera 2. That is, the stop of the move of the cover 32 toward the opening direction D1 may be act as the way to activate the camera function. With this design, the user can take a photo without further operating the portable electronic device, which has the advantage of slide-and-shoot. In practical applications, the camera 2 can be activated when the cover 32 is sliding along the opening direction D1 through the circuit design of the portable electronic device, which can reduce the time required to activate the function of the camera and is advantageous for the real-time photo-shooting reaction of the user.

On the other hand, when the cover 32 slides toward the opening direction D1 until being stopped, the thickness of the side of the convex portion is the sum of the original thickness of the convex portion 11 and the thickness of the cover 32. The thickness for the user to grip is increased due to the overlap state of these two components, which is advantageous for the user to have a more comfortable gripping when take photos with a slim-type smartphone.

It is noteworthy that when the sliding portion 321 slides in the inclined slideway 31, the sliding portion 321 does not contact with the second inclined surface 315. Thus, the damage due to the collision between the sliding portion 321 and the inclined slideway 31 can be prevented. Moreover, by providing the first inclined surface 314 at the side of the stop portion 312, when the sliding portion 321 is stopped by the stop portion 312, at least a portion of the sliding portion 321 can be rested on the first inclined surface 314 without hanging in the inclined slideway 31. With such design, the stability of the overall sliding cover structure can be enhanced when the camera is exposed, and the stability of taking pictures for the user can also be enhanced.

FIG. 2B is a schematic diagram showing the cover 32 moving from one side of the convex portion 11 to the camera 2. When the user wants to cover the camera of the portable electronic device E to isolate the camera from the outside, the cover 32 can be moved toward a closing direction D2 until the cover 32 covers the camera completely. When the sliding cover structure 3 covers the camera 2 completely, the sliding cover structure 3 is substantially in a flat state with the convex portion 11. That is, when the sliding cover structure 3 covers the camera 2 completely, the back of the main body 1 is in a flat state and the convex portion 11 is exposed completely. This beautifies the appearance of the portable electronic device E and prevents the cover from being damaged due to external factors.

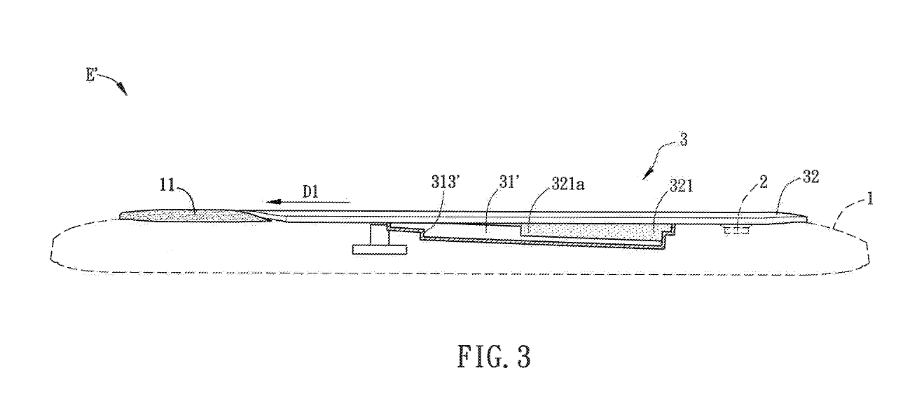

FIG. 3 is a side view of the portable electronic device according to another preferred embodiment of the invention. Referring to FIG. 3, in the present embodiment, the portable electronic device E′ has structures and features substantially similar to those of the portable electronic device E of the previous embodiment. The difference is in that the inclined slideway 31′ further has a block portion 313′. The over 32 can be slid toward the convex portion 11 along the opening direction D1 by users for activating the function of the camera 12. When the cover 32 slides at the inclined slideway 31 and the camera 2 is not completely exposed, the first end 321a of the sliding portion 321 immediately touches the block portion 313′. At this moment, since the cover 32 can still slide toward the convex portion 11 along the opening direction D1, the sliding portion 321 may be deviated toward a direction perpendicular to the opening direction D1 to avoid the block portion 313′ and keep moving toward the opening direction D1 until the camera 2 is completely exposed. With the design of this block portion, the sliding cover structure 3 may have a two-stage opening function, Which can prevent the user from inadvertently touching the sliding cover structure 3 to activate the camera function. On the other hand, it can also prevent the user from causing the problem of unknowingly moving the sliding cover structure 3 due to external force and wasting the electric power of the portable electronic device E.

To sum up, the sliding cover structure provided by the invention is used with a portable communication device, such as a smartphone. By providing a slidable cover on a slim-type smartphone, the cover can cover the camera on the back of the smartphone, so that the camera can be isolated from the external factors affecting the image quality, such as moisture, dusts and mechanical damages, and the protection function can be achieved.

Additionally, the portable electronic device (such as but not limited to a smartphone) with the sliding cover structure of the invention is designed that the camera function can be activated quickly when the cover is opened to expose the camera. That is, the invention can Use the sliding cover structure as a real hotkey to replace the operation unit in the smartphone and achieve the advantage of slide-and-shoot.

Moreover, with the design of having an inclined angle inside the sliding cover structure, the slimness of the smartphone can be maintained by accommodating the cover in the space of the slideway when the cover covers the camera. When the cover slides along the convex portion on the back of the phone to expose the camera, the cover overlaps with the convex portion on the same side of the phone, and the gripping thickness for the user can be increased through such overlap. In practical applications, the sliding cover structure of the invention allows the phone to maintain its slimness while thickening the phone locally via the slidable cover to increase the degree of comfort when gripping the phone for photo-taking.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A portable electronic device, comprising:
a main body, one surface of which having a convex portion and a planar portion;
a camera provided at the planar portion; and
a sliding cover structure provided at the planar portion, the sliding structure including:
an inclined slideway provided at the planar portion, the inclined slideway being inclined from the convex portion toward the camera to form an inclined angle with a horizontal axis of the main body; and
a cover having at least one sliding portion, the cover sliding along the inclined slideway via the sliding portion and movably covering the camera, wherein when the cover covering the camera slides to the convex portion and at least a portion of the cover covers the convex portion, the camera is exposed.

2. The portable electronic device according to claim I, wherein when the cover is provided at the planar portion and covers the camera, the cover and the convex portion are substantially in a flat state.

3. The portable electronic device according to claim 1, wherein the sliding portion is slidably lodged at the inclined slideway.

4. The portable electronic device according to claim 1, wherein the inclined slideway further includes two fixing portion, and the sliding portion is slidably sleeved at the fixing portions.

5. The portable electronic device according to claim 1, further comprising:
a stop portion provided at the inclined slideway.

6. The portable electronic device according to claim 5, wherein when the camera is completely exposed, the stop portion stops the slide of the cover.

7. The portable electronic device according to claim 6, wherein when the stop portion stops the slide of the cover, an angle between the cover and the main body equals to the inclined angle.

8. The portable electronic device according to claim 1, wherein when the cover covers the camera completely, the convex portion is exposed completely.

9. The portable electronic device according to claim 1, wherein when the cover covering the camera slides to the convex portion and at least a portion of the cover covers the convex portion, the portable electronic device activates function of the camera.

10. The portable electronic device according to claim 1, wherein the inclined slideway comprises a first inclined surface and a second inclined surface, the slope of the first inclined surface is larger than the slope of the second inclined surface.
